(19) United States
(12) Patent Application Publication
(10) Pub. No.: US 2025/0268373 A1
(43) Pub. Date: Aug. 28, 2025

(54) SECURE MOBILE DEVICE DISPLAY MOUNT

(71) Applicant: RTF Global Inc., Orangeville (CA)

(72) Inventor: Stefan Wiesen, Orangeville (CA)

(73) Assignee: RTF Global Inc., Orangeville, ON (CA)

(21) Appl. No.: 19/059,252

(22) Filed: Feb. 20, 2025

Related U.S. Application Data
(60) Provisional application No. 63/558,308, filed on Feb. 27, 2024.

(51) Int. Cl. A47B 23/04; F16B 2/10; F16B 2/12; F16B 2/18; F16M 13/02

(52) U.S. Cl. CPC A47B 23/043; F16B 2/10; F16B 2/12; F16B 2/18; F16M 13/02

(57) ABSTRACT

A secure mobile device mount comprised of a hinge body, west claw, east claw and north claw. A mobile device is secured within the mount via claws and the whole is secured to a display platform (i.e. a table) via a base. A damper system biases the hinge body to the closed position. In the closed position, the front surface of the mobile device is viewable by a consumer. By rotating the hinge body to the open position, the rear surface (i.e. cameras) of the mobile device may be exposed for viewing by the consumer.

### FIELD OF THE INVENTION

The present specification relates generally to display mounts for mobile devices, and more particularly to a secure display mount for a mobile phone device.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

Mobile devices, particularly phones, have become ubiquitous in daily life and, as a consequence, are available from a variety of vendors, both affiliated with mobile services and independent. As with many products, users generally prefer to physically handle the mobile device to gauge its features and assess its desirability. However, due to the relatively small size and high value of mobile devices, theft of the mobile device from the display is a significant risk and concern for the vendor.

Accordingly, various types of mobile device mounts have been developed to provide a secure mount and reduce theft of mobile devices from commercial displays. Most commonly, the mobile device is secured to a rigid frame or case which is then further secured to the display. The frame is often secured with a tamper-resistant cable in order to allow consumers to handle the device. However, these cables are vulnerable to being severed or detached, thus other systems which are more directly secured to a table or other display platforms have been introduced.

One issue that has arisen with the advent of more modern mobile devices is the need for the user to view the rear side of the device in order to assess features such as cameras and secondary displays. The current solutions have the mobile device secured to a base which prevents the rear side of the device from being exposed or viewed. Accordingly, in order to view the rear side of the device, the device must be removed from the secure mount, defeating the purpose of the mount.

Thus, it would be desirable to have a secure mobile device display mount which provides this improvement and/or mitigates some of the known disadvantages.

Accordingly, there remains a need for improvements in the art.

### SUMMARY OF THE INVENTION

In accordance with an aspect of the invention, there is provided a secure display mount for a mobile phone device.

According to an embodiment of the invention, there is provided a secure mobile device mount comprised of a hinge body, a west claw, an east claw and a north claw. A mobile device is secured within the mount via the claws and the whole is secured to a display platform (i.e. a table) via a base.

The west claw is rotatable between an open and a closed position. In the closed position, the front surface of the mobile device is viewable by a consumer. By rotating the hinge body to the open position, the rear surface (i.e. cameras) of the mobile device may be exposed for viewing by the consumer. A damper system biases the west claw to the closed position.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1A is an exploded view of a west (left) claw of a secure mobile device mount according to an embodiment;

FIG. 1B is a section view of the spindle assembly of FIG. 1A;

FIG. 1C is a section view of the damper system of FIG. 1A;

FIG. 1D is a perspective view of a north (top) claw of a secure mobile device mount according to an embodiment;

FIG. 1E is an exploded view of a east (right) claw of a secure mobile device mount according to an embodiment;

FIG. 1F is a plan view of a secure mobile device mount according to an embodiment;

FIG. 2 is a front left perspective view of the device;

FIG. 3 is a front left perspective view of the device with a phone secured therein;

FIG. 4 is a front right perspective view of the device of FIG. 3 in an open position;

FIG. 5 is a top perspective view of FIG. 4; and

FIG. 6 is a rear side view of FIG. 2.

Like reference numerals indicated like or corresponding elements in the drawings.

### DETAILED DESCRIPTION OF THE EMBODIMENTS

The present invention relates generally to display mounts for mobile devices, and more particularly to secure display mount for a mobile phone device.

### Parts List

1—Hinge body
2—West Claw—return spring
3—Damper—Drive gear
4—Damper—Drive gear
5—Damper—modified
6—West Claw
7—Spindle
8—North Claw—Ratchet plate
9—Spindle collar
10—East Claw—Clamp Screw support (upper)
11—East Claw—Clamp Screw support (lower)
12—East Claw—Clamp nut
13—East Claw—Clamp screw
14—East Claw—Guide
15—East Claw
16—North Claw—Catch housing
17—North Claw—Pawl Return spring
18—North Claw—Pawl Cam
19—North Claw—Arm
20—North Claw—Retainer
21—Hinge Body—Base mount screw cover
22—Pad—West Claw
23—Pad—East Claw
24—Pad—North Claw
25—Pad—North Claw—retainer screw cover
26—Pad—Bumper
27—Bearing
28—Set screw
29—Screw
30—Screw
31—Screw
32—Screw
33—Screw
34—Set screw
35—Set screw
36—E-clip
37—Spring
38—Washer
39—Nut
40—Clamp Screw
50—Base
100—Secure mobile device holder
120—North claw
130—Mobile device

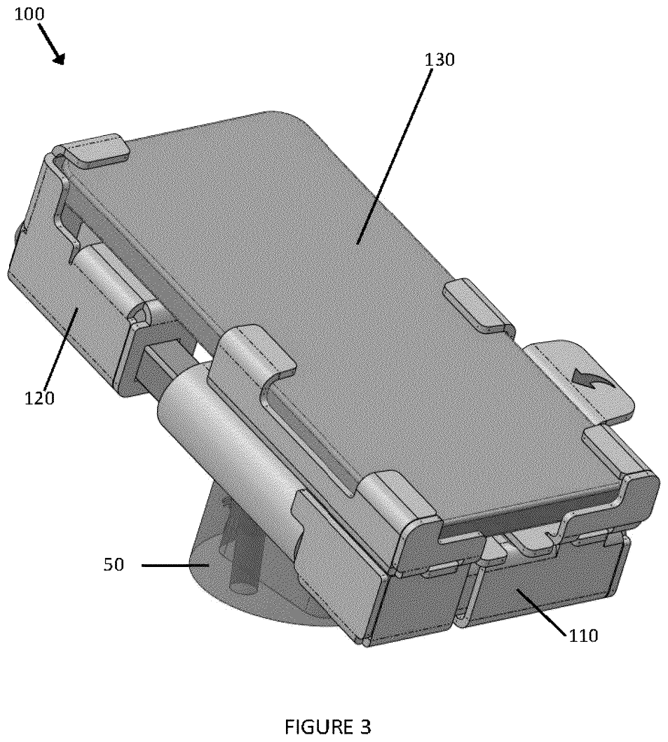

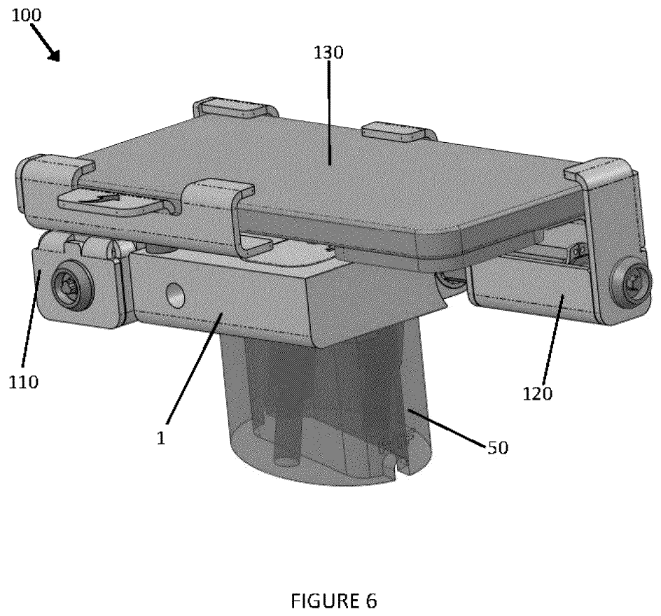

The present secure mobile device holder 100 as shown in the drawings is generally formed from a hinge body 1, with a west (left) claw 6, a north (top) claw 120 and an east (left) claw 15 which cooperate to secure a mobile device 130 within the hinge body 1 as shown in FIGS. 3 and 6.

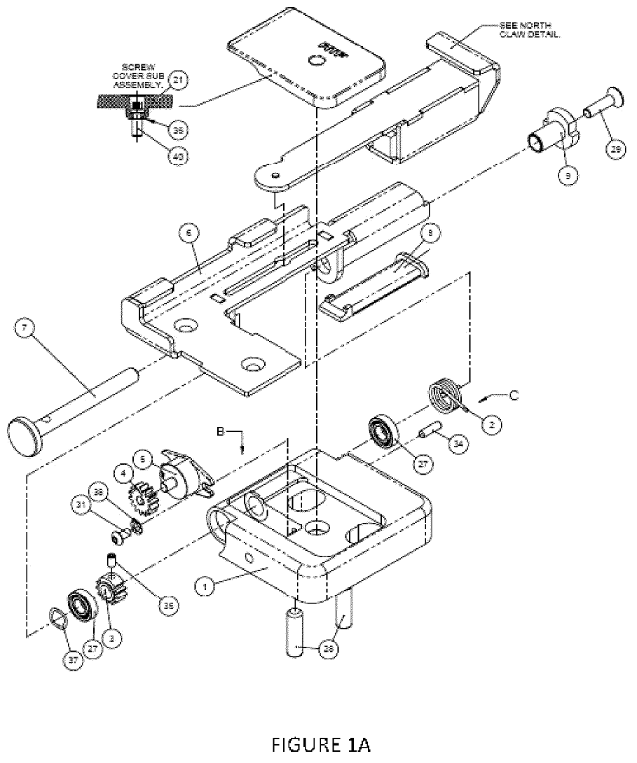

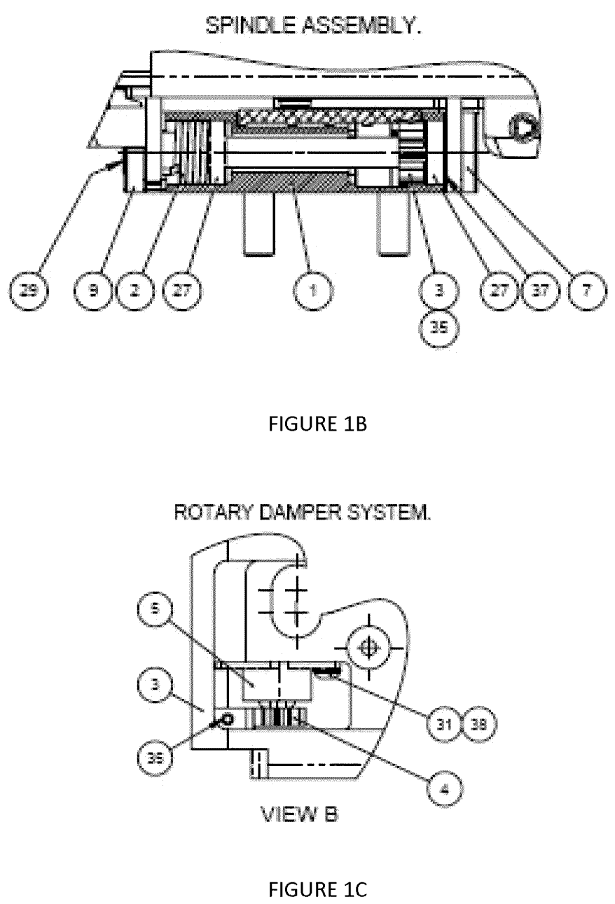

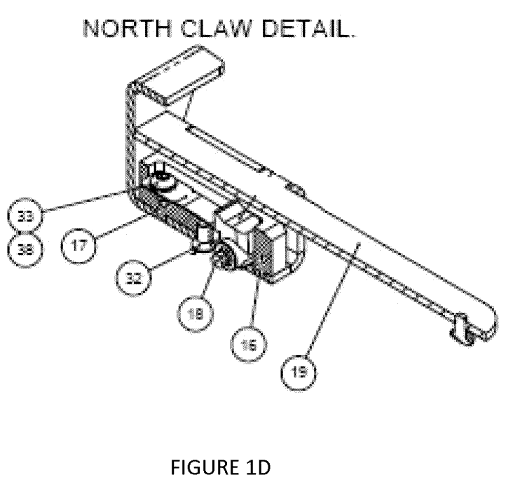

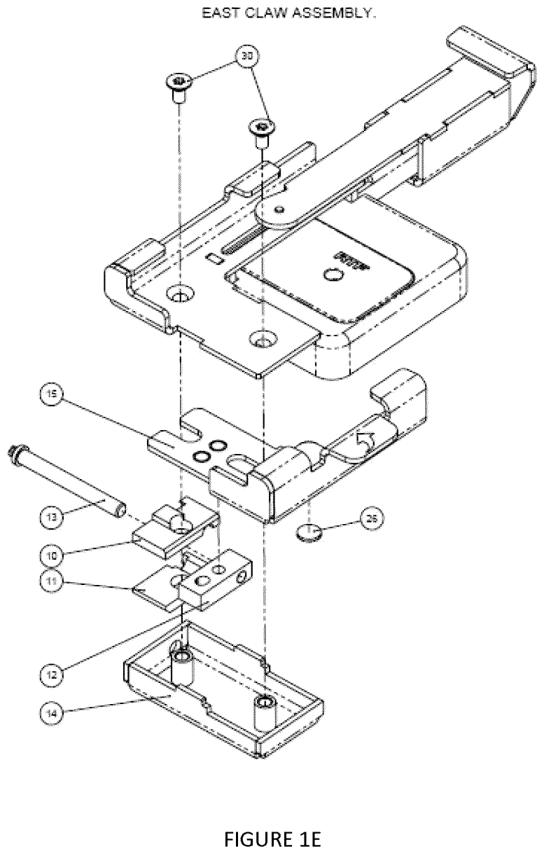

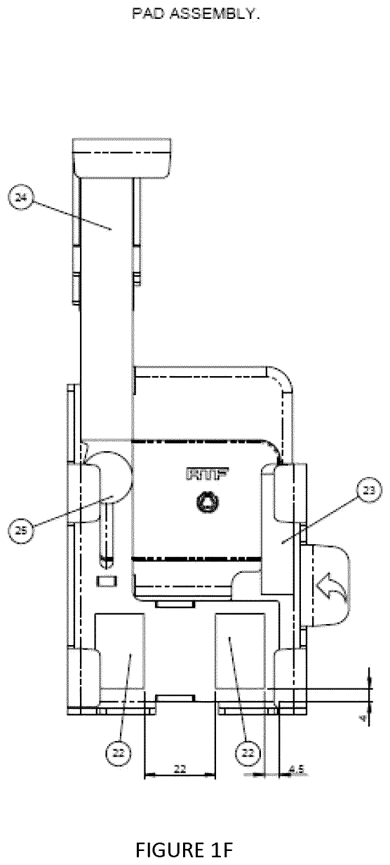

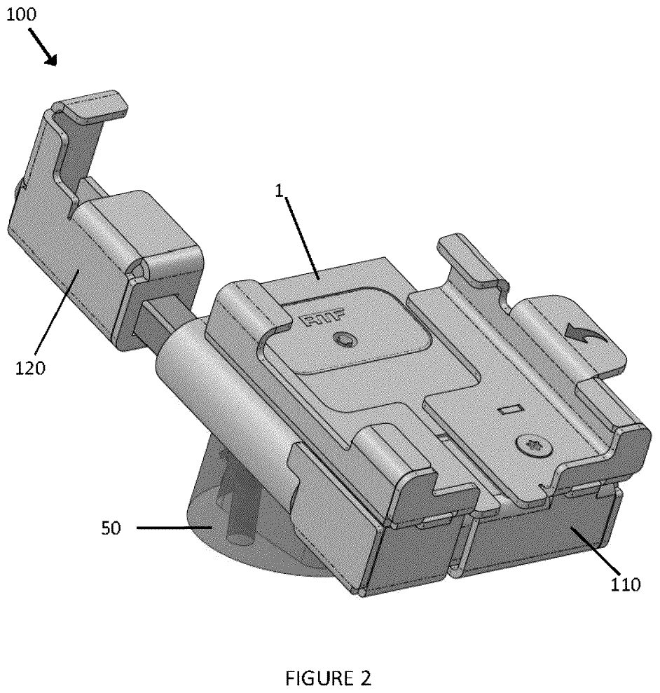

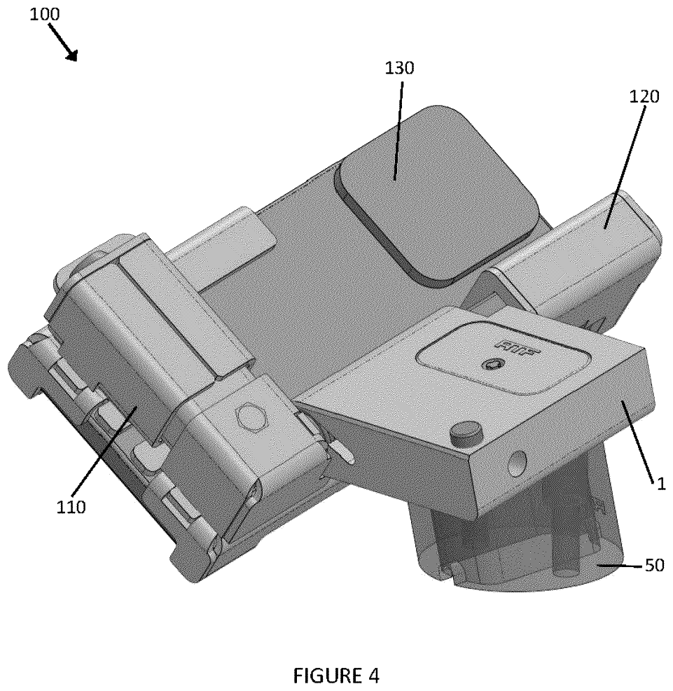

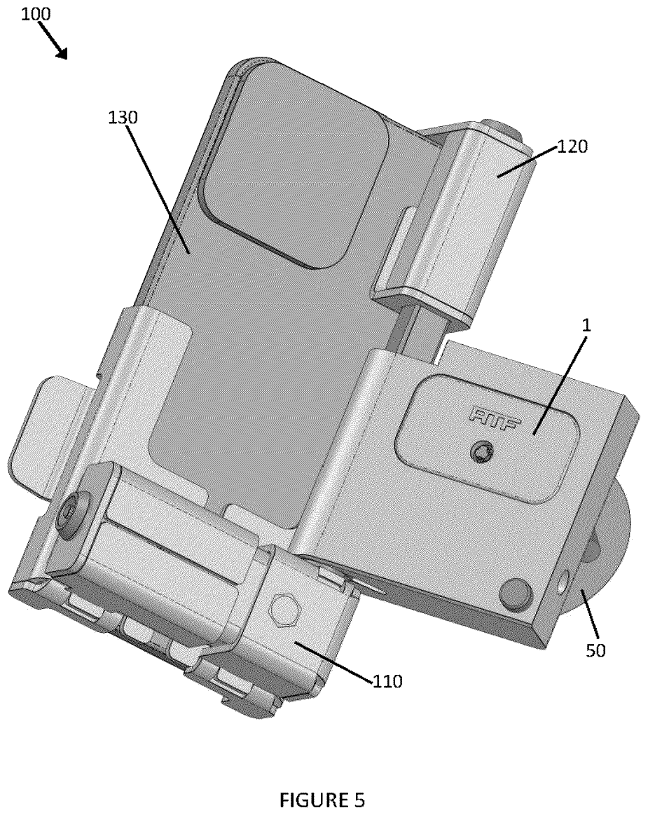

The west claw 6 is formed with a spring 2 and spindle 7 which enable rotation of the west claw 6 within the hinge body as shown in FIGS. 4 and 5. The spindle assembly, as shown in FIG. 1B, uses drive gears 3 and 4 to provide a rotational damper system 5 (as shown in FIG. 1C) which both restricts the rotational movement of west claw 6, as well as providing a force (via spring 2) to restore west claw 6 to a default position against hinge body 1, as shown in FIG. 2.

North claw 120 is adjustable via pawl spring 17 and cam 18 to ensure that north claw 120 is securely retained against the top edge of mobile device 130. North claw 120 is further lockable in position via cam 18 to inhibit removal of the mobile device 130 once secured in position.

East claw 15 is secured to hinge body 1 and is further adjustable via clamp screw 13 such that the distance between west claw 6 and east claw 15 is sufficient to permit insertion of mobile device 130 while ensuring that mobile device 130 is secured beneath the top protrusion of both west claw 6 and east claw 15 to further inhibit removal of the mobile device 130 once secured.

Hinge body 1 is further secured to a base 50 via screws 22, which is itself further secured to a table or similar platform (not shown) for displaying mobile devices to consumers.

In operation, the mobile device 130 is secured within the mobile device holder 100 via the north claw 120 and underneath west claw 6 and east claw 15 with the rear surface of the mobile device 130 resting on top of the hinge body 1. The front surface of the mobile device 130 is thus visible to the consumer while on display.

Then, when the consumer wishes to look at the rear surface of mobile device 130, in order to assess the cameras, for example, which are generally positioned on the top right rear surface of the mobile device 130, the hinge body 1 may be rotated as shown in FIGS. 4 and 5 to expose the rear surface for viewing. Damper system 5 in cooperation with spring 2 then biases the hinge body 1 towards returning to the original closed position as shown in FIGS. 2 and 6.

Therefore, the mobile device 130 may have both surfaces exposed for view to a consumer without compromising the security provided by the claws 6, 15 and 120 and the overall mount 100.

If desired a tab or similar protrusion may be included to assist in rotating the hinge body 1. As shown herein, an exemplary protrusion is shown on the right edge of east claw 15.

Note that while the north claw 120 is positioned to the left side of the mobile device holder 100, according to the standard position of mobile device cameras on the right side, the overall design may be reversed to accommodate present or future devices that may require viewing the rear face on the left side of the device rather than the right.

Further, the assembly and adjustment screws (28-35, inclusive) may be concealed via covers, or by pads 22-25 to prevent tampering or theft. Pads 22-25 also provide protection for mobile device 130 from scratches or other abrasions from the hinge body 1 and claws 6, 15 and 120.

It should also be noted that the steps described in the method of use can be carried out in many different orders according to user preference. The use of “step of” should not be interpreted as “step for”, in the claims herein and is not intended to invoke any statutory provisions. It should also be noted that, under appropriate circumstances, considering such issues as design preference, user preferences, marketing preferences, cost, structural requirements, available materials, technological advances, etc., other methods are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the patent office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A secure mobile device display mount, comprising:
a hinge body dimensioned to hold a mobile device;
a west claw secured to the hinge body, the west claw rotatable relative to the hinge body, the west claw comprising one or more protrusions extending over the mobile device when the mobile device is one the hinge body;
a north claw secured to the hinge body, the north claw adjustable in length, the north claw comprising one or more protrusions extending over the mobile device when the mobile device is one the hinge body;
an east claw secured to the hinge body, the east claw adjustable in distance between the west claw and the east claw, the east claw comprising one or more protrusions extending over the mobile device when the mobile device is one the hinge body;
wherein a rear surface of the mobile device is exposed when the west claw is rotated.

2. The mount of claim 1, further comprising a rotational damper engaged to the west claw, the rotational damper operative to limit rotational movement of the west claw.

3. The mount of claim 1, wherein the rotational damper further biases the rotation movement of the west claw towards the hinge body.

4. The mount of claim 1, further comprising a pawl spring and cam mechanism coupled to the north claw, the pawl spring and cam mechanism operative to perform the adjustment of the length of the north claw.

5. The mount of claim 1, further comprising a clamp screw coupled to the east claw, the clamp screw operative to provide adjustment of the distance between the west claw and the east claw.

6. The mount of claim 1, further comprising one or more pads secured to the hinge body, the west claw, the north claw and the east claw.

7. A method of securing a mobile device in a secure mobile device display mount, comprising:
placing the mobile device on a hinge body, the hinge body comprising a west claw, a north claw and an east claw, such that one edge of the mobile device contacts the west claw;
adjusting the north claw in length such that the north claw contacts a second edge of the mobile device;
adjusting the east claw such that the east claw contacts a third edge of the mobile device;
locking all adjustments such that the mobile device is secured to the hinge body;
wherein the west claw is rotatable such the when the west claw is rotated, a rear surface of the mobile device is exposed.

8. The method of claim 7, wherein the west claw further comprises a rotational damper, the rotational damper operative to limit rotational movement of the west claw.

9. The method of claim 7, wherein adjustment of the length of the north claw is performed via adjustment of a pawl spring and cam mechanism coupled to the north claw.

10. The method of claim 7, wherein adjustment of the east claw is performed via adjustment of a clamp screw coupled to the east claw.
